(19) United States
(12) Patent Application Publication
(10) Pub. No.: US 2013/0312967 A1
(43) Pub. Date: Nov. 28, 2013

(54) METHOD FOR LIMITING THE WATER OR GAS CONING IN AN EXTRACTION WELL OF A HYDROCARBON FLUID

(71) Applicants: Giambattista De Ghetto, San Donato Milanese (MI) (IT); Mario Augusto Chiaramonte, Milano (IT)

(72) Inventors: Giambattista De Ghetto, San Donato Milanese (MI) (IT); Mario Augusto Chiaramonte, Milano (IT)

(73) Assignee: ENI S.p.A., Roma (IT)

(21) Appl. No.: 13/976,745

(22) PCT Filed: Dec. 27, 2011
(86) PCT No.: PCT/IB11/55965

§ 371 Date: Aug. 12, 2013

(30) Foreign Application Priority Data
Dec. 27, 2010 (IT) MI2010A 002411

(51) Int. Cl. C09K 8/502

(52) U.S. Cl. CPC C09K 8/502
USPC 166/292

(57) ABSTRACT

The present invention relates to a method for limiting the water or gas coning in an extraction well of a hydrocarbon fluid from an underground reservoir, said reservoir being close to an aquifer or cap gas, said method comprising the following operative phases: i) injecting a treatment fluid into the subsoil, having an intermediate density between that of the hydrocarbon fluid and that of the water of the aquifer or the cap gas, said treatment fluid being insoluble in said hydrocarbon fluid, said water and/or said cap gas; ii) waiting for the treatment fluid to settle by gravity at the hydrocarbon fluid/water or hydrocarbon fluid/gas interface; iii) in situ activating said treatment fluid and forming a substantially horizontal permeability barrier with respect to the water of the aquifer or the cap gas. The present invention also relates to a confinement system consisting of a barrier impermeable to water or gas obtained with the above method.

The present invention relates to a method for limiting the water or gas coning in an extraction well of a hydrocarbon fluid from an underground reservoir. In particular, the present invention relates to a method for limiting the water or gas coning based on the interpositioning of a confinement system consisting of a barrier impermeable to water or gas. The present invention also relates to the above confinement system.

For the purposes of the present invention, the term “hydrocarbon fluid” refers to a liquid or gaseous fluid of a natural origin present in an underground reservoir. The terms petroleum, oil and hydrocarbon oil are used alternatively in the following present description.

The water coning or the gas coning is a phenomenon which interests the extraction activity of hydrocarbon fluids (for example, petroleum or natural gas) from underground reservoirs by means of oil wells.

In the case of water coning, this phenomenon is linked to the presence of an aquifer in the layers of earth beneath the reservoir of liquid or gaseous hydrocarbon fluid which is to be extracted.

Due to the depression created by the extraction activity of the hydrocarbon fluid from the reservoir, the water of the underlying aquifer is dragged upwards in the direction of the extraction well (according to a cone-shaped profile), and is thus extracted together with the hydrocarbon fluid. Furthermore, as the extraction operations continue, the amount of water which is extracted together with the hydrocarbon fluid, tends to significantly increase specifically as a result of this water coning phenomenon.

The coproduction of a hydrocarbon fluid mixed with high quantities (cuts) of water, considerably reduces the extraction efficiency of the fluid, increases the costs and dimensions of the equipment necessary for the separation of the water from the fluid, increases the overall production costs and, finally, creates the problem of the disposal of the water under safety conditions for the environment.

The gas coning phenomenon derives from the presence of an accumulation of gas (cap gas) in a rocky layer above an oil reservoir. The cap gas may be of a natural origin or it may derive from extraction operations for exploiting the reservoir. Analogously to what takes place in the case of water coning, due to the depression created by the extraction activity of the hydrocarbon fluid from the reservoir, a local deformation of the gas/oil interface can be created with a consequent entrainment of the cap gas towards the extraction well (according to an inverse cone profile with respect to the case of water coning).

Various solutions to the problem of water coning and gas coning have been proposed in the state of the art. Among the proposed solutions, there is the construction of mechanical barriers in the immediate vicinity of the well by injections of chemical compounds such as polymers, gels or foams, or the directed drilling of wells, i.e. the drilling of extraction wells having paths and completions specifically studied for reducing the coning phenomena.

U.S. Pat. No. 5,062,483 describes a method for reducing the water coning in an oil reservoir with a high water cut. The method provides the injection inside the reservoir of a mass of uncondensable gas (for example air or natural gas) through an injection well situated close to the extraction well. This injection increases the gas saturation of the reservoir around the extraction well. In a subsequent phase, the method provides the injection of a further quantity of uncondensable gas through the extraction well and the production start-up of the extraction well itself.

U.S. Pat. No. 3,965,986 describes a method for reducing the water coning based on the reduction of the water permeability of selected layers of the reservoir, thus slowing down the migration of water towards the extraction well. The reduction in the permeability is obtained through a first injection of an aqueous dispersion of colloidal silica, followed by a second injection of water containing a surfactant, with the formation of a gel which blocks the high permeability porous matrix.

The methods for reducing the effects of water or gas coning known in the state of the art have various disadvantages. First of all, they only produce containment effects in the immediate vicinity of the extraction well (within a radius in the order of a few meters of distance from it), thus providing extremely limited benefits. Secondly, they envisage the injection of chemical compounds inside the hydrocarbon fluid to be extracted, with a high risk of irremediably damaging the reservoir in the case of error in injecting the chemical compounds. Finally, the injection of chemical compounds into the reservoir according to the known art is not capable, except for an extremely limited extent, of creating permeability barriers in precise portions of the subsoil, i.e. in the points in which they can be most necessary or effective.

Considering the above status of the art in the field of the oil industry, the need is still extremely felt for finding alternative, and possibly more advantageous and effective, methods for opposing the effects of water and gas coning.

An objective of the present invention is to overcome the drawbacks revealed in the state of the art.

An object of the present invention therefore relates to a method for limiting the water or gas coning in an extraction well of a hydrocarbon fluid from an underground reservoir, said reservoir being close to an aquifer or cap gas, said method comprising the following operative phases:

i) injecting a treatment fluid into the subsoil, having an intermediate density between that of the hydrocarbon fluid and that of the water of the aquifer or the cap gas, said treatment fluid being insoluble in said hydrocarbon fluid, said water and/or said cap gas;

ii) waiting for the treatment fluid to settle, for example by gravity or hydrostatic thrust, at the hydrocarbon fluid/water or hydrocarbon fluid/gas interface;

iii) in situ activating said treatment fluid and forming a permeability barrier with respect to the water of the aquifer or the cap gas, preferably arranged in a substantially horizontal position.

A second object of the present invention relates to a confinement system of an underground reservoir of a hydrocarbon fluid, said reservoir being close to an aquifer or cap gas, said confinement system comprising a permeability barrier to the water of the aquifer or cap gas, preferably arranged in a substantially horizontal position, at the hydrocarbon fluid/water interface or hydrocarbon fluid/gas interface, consisting of a treatment fluid, possibly activated in situ, having an intermediate density between that of said hydrocarbon fluid and that of said water or said cap gas, said treatment fluid also being insoluble in said hydrocarbon fluid, said water and/or said gas.

For a better understanding of the characteristics of the present invention, reference will be made in the description to the following figures:

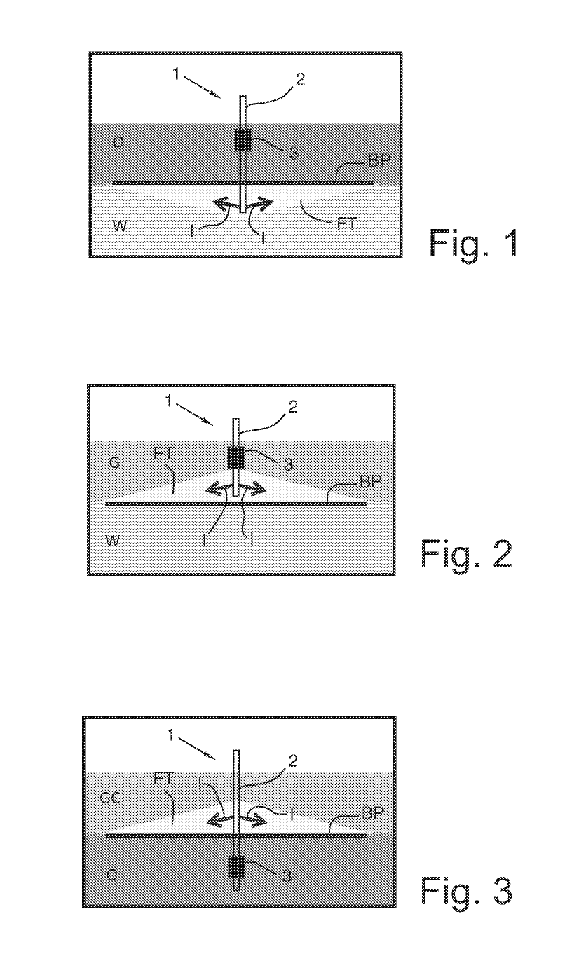

FIG. 1: schematic representation of the application of the method, object of the present invention, for preventing the water coning phenomenon in a reservoir in which the hydrocarbon fluid is an oil;

FIG. 2: schematic representation of the application of the method, object of the present invention, for preventing the water coning phenomenon in a reservoir in which the hydrocarbon fluid is a gas;

FIG. 3: schematic representation of the application of the method, object of the present invention, for preventing the gas coning phenomenon in a reservoir in which the hydrocarbon fluid is an oil.

In the above figures, “O” represents the oil, “W” the aquifer, “G” the hydrocarbon gas, “GC” the cap gas, “FT” the treatment fluid, “BP” the permeability barrier at the oil/water contact interface (FIG. 1), gas/water contact interface (FIG. 2) and oil/cap gas contact interface (FIG. 3). In each of FIGS. 1-3, the reference number 1 indicates an extraction well in which a duct 2 of the hydrocarbon fluid extracted and a production area 3, can be distinguished. The well consists of a cemented pipe (casing), in whose interior there is a steel pipe (tubing). The fluid produced leaves the formation passing through a production area (“shots” in the casing) and enters the tubing. The arrows “I” schematically indicate the flow direction of the treatment fluid injected.

The method, object of the present invention, allows the extraction efficiency of an oil well to be increased, in both the case of liquid hydrocarbon fluids (oil) and also in the case of gaseous hydrocarbon fluids (natural gas), considerably preventing or delaying the oncoming of water and gas coning effects.

In particular, the above method allows the formation in situ of a permeability barrier to water or cap gas, exactly positioned at the contact interface between the hydrocarbon fluid and water, in the case of reservoirs subject to water coning (FIGS. 1 and 2), or between the hydrocarbon fluid and cap gas, in the case of reservoirs subject to gas coning (FIG. 3).

The permeability barrier that can be obtained with the above method can have considerable sizes, as far as occupying an area which extends within a radius of various tens of meters from the extraction well. A barrier of this kind therefore exerts a much higher attenuation effect of coning phenomena with respect to what can be obtained with the methods of the known art, up to the point of preventing its formation in the most favourable of cases.

The method, object of the present invention, also offers the advantage of being able to be applied either before initiating the exploitation of the reservoir, i.e. before the extraction well has entered “in production”, or after the exploitation has already started. In the latter case, however, it is preferable to apply the method before the first undesired water and/or gas coning effects begin to become manifest.

The method, object of the present invention, is based on the formation in situ of a permeability barrier by the injection into the subsoil of a suitable treatment fluid and subsequent activation of this fluid.

The treatment fluid is a fluid having physico-chemical characteristics which are such that, once it has been injected into the subsoil, it is capable of migrating until it reaches the contact interface between the hydrocarbon fluid of the reservoir and the aquifer or the contact interface between the hydrocarbon fluid of the reservoir and the cap gas. The migration of the treatment fluid towards the contact interface substantially takes place as a result of the difference in density existing between the treatment fluid, the hydrocarbon fluid and the water or cap gas.

In particular, the treatment fluid has an intermediate density between that of the hydrocarbon fluid and that of the water or cap gas in contact with it and must be insoluble in the water or cap gas, depending on the specific case.

In the case of reservoirs whose permeability (of the aquifer) is particularly low, an expert in the field can possibly increase the migration rate of the treatment fluid at the interface by alternating injections of water with injections of the fluid itself.

The treatment fluid which can be used in the method, object of the present invention, can be selected by an expert in the field from numerous materials having an intermediate density suitable to form a barrier under the conditions existing at the interfaces present in the oil or gas reservoir of interest. It generally comprises a carrying means and an active principle capable of forming, under certain conditions, a barrier impermeable to water or gas. The active principle can be an organic polymer capable of swelling or forming a gel in water, such as for example, polyacrylamides, partially hydrolyzed polyacrylamides or polysaccharides which can be activated by means of an organic or inorganic crosslinker, or an inorganic polymer such as silicates.

If it is a liquid, said treatment fluid preferably consists of an oil-in-water emulsion in which the hydrocarbon phase carries a polymer (for example polypropylene, polyethylene, polyurethane) capable of swelling in the presence of oil once it has reached the interface and under suitable activation conditions, or said hydrocarbon phase contains, in its interior, a suitable surfactant capable of favouring the formation of water-in-oil-type emulsions, such as, for example, the emulsions described in published international patent application WO07/112,967, or in Italian patent Nr. 1349321.

According to another embodiment, said hydrocarbon phase is incompatible with the crude oil present in the reservoir inducing, when in contact with the same, the precipitation of the asphaltenes present in the oil. In this case, the organic phase of the mixture essentially consists of paraffins.

For the prevention of the water coning phenomenon, the density of the treatment fluid is typically intermediate between the density of the hydrocarbon phase (typically ranging from 0.7 to 0.9 g/cc) and that of the formation water (typically ranging from 1 to 1.2 g/cc). Once positioned at the contact interface, the treatment fluid is activated in situ, i.e. it undergoes transformations of the chemical or physical type which lead to the formation of a barrier substantially impermeable to the water coming from the aquifer, or cap gas. Depending on the type of treatment fluid selected, the in situ activation can start spontaneously by chemical reaction between the treatment fluid and one of the phases at the interface, or it can be induced by the chemical and/or physical conditions at the interface.

The treatment fluid can, for example, be a fluid which, when in contact with water, produces an emulsion impermeable to water or cap gas.

In a second embodiment, the treatment fluid can be selected so as to create a high-viscosity phase at the contact interface, which produces the above impermeability effect to water or cap gas.

In a further embodiment, the treatment fluid can have such characteristics as to induce the precipitation of asphaltenes once it has come into contact with the hydrocarbon fluid.

As already mentioned, the in situ activation can also be induced after the positioning of the treatment fluid at the contact interface.

In a preferred embodiment, for example, the treatment fluid can comprise a monomer or a pre-polymer, whose polymerization is completed in situ by putting the monomer or pre-polymer in contact with a polymerization initiator.

In the case of polymerization in water, examples of monomers or pre-polymers which can be used are compounds belonging to the following groups: amides, polyamides, ethylene-glycols, polyethyleneglycols, acrylamides, polyacrylamides, polysaccharides.

Examples of polymerization initiators which can be used are compounds belonging to the following groups: inorganic agents based on chromium or zirconium, or organic agents such as phenols or formaldehyde.

The polymerization initiator can be put in contact with the monomer or pre-polymer by injection into the subsoil of a second treatment fluid comprising said initiator, in the same point in which the monomer or pre-polymer was injected. Completion of the polymerization leads to the formation of a polymer having such a consistency (for example a gel) as to create a permeability barrier to water or cap gas.

In an embodiment alternative to the former one, the treatment fluid can comprise a colloidal silica, which can be transformed into a gel after the injection of a second treatment fluid comprising a surfactant. The treatment fluid can also comprise anoil soluble alkyl- or alkoxy-silane, such as, for example, trimethoxymethylsilane, trimethylisopropoxysilane, tetraethylsilane, which, upon contact with the aquifer at the oil-water interface, hydrolyzes forming a silica gel. A particularly preferred alkoxy-silane compound is trimethoxymethylsilane (TMOS), which is insoluble in water and slightly soluble in oil.

In a further embodiment of the present invention, the treatment fluid comprises a silicone polymer or prepolymer having an intermediate density between the water of the aquifer and the oil of the reservoir, for example certain marketed silicones, normally used as adhesives or sealants. Preferably the silicone polymer or prepolymer is dissolved in a hydrocarbon solution, at concentrations between 2 and 20% by weight, more preferably in a hydrocarbon having a high flash-point, suitable for the usually elevated temperatures of the reservoir. Preferably, the hydrocarbon solution of the silicone compound is injected in the aquifer, below the oil-water interface, at a point not far from it, so as to allow the silicone compound solution to migrate and place itself at the interface before crosslinking.

The silicone polymer or prepolymer can be crosslinked by injecting it with a suitable crosslinker, however, in most cases it crosslinks of its own by contact with water, within times long enough to allow it to migrate to the interface. In a particular embodiment, the skilled person can regulate within certain ranges the times of crosslinking and barrier formation, by adjusting the concentration of the silicone polymer or prepolymer in the hydrocarbon solvent.

The above chemical compounds which can be used for the preparation of the treatment fluid are known in the state of the art and are commercially available.

The injection of the treatment fluid(s) can be effected in various points of the subsoil.

The treatment fluid is preferably injected into the subsoil inside the aquifer, as illustrated in FIG. 1, or inside the cap gas, as illustrated in FIG. 2. In this way, in fact, the composition of the hydrocarbon fluid to be extracted is not altered. Furthermore, in the case of error in injecting the treatment fluid, the exploitation of the reservoir containing the hydrocarbon fluid is not irreversibly jeopardized, as is the case, on the contrary, with the methods known in the state of the art.

With reference to FIG. 1, in a preferred embodiment, the method, object of the present invention, can be applied for reducing the water coning phenomenon in the extraction of a liquid hydrocarbon fluid (oil O) present in a reservoir overlying an aquifer W. In this case, the treatment fluid FT which can be used is a fluid immiscible with the water of the aquifer W and with the oil O, and having a density lower than that of the water and higher than that of the oil O. The treatment fluid FT is preferably injected directly into the aquifer W.

With reference to FIG. 2, in a second preferred embodiment, the method, object of the present invention, can be applied for reducing the water coning phenomenon in the extraction of a gaseous hydrocarbon fluid (for example, a natural gas G) present in a reservoir overlying an aquifer W. In this case, the treatment fluid FT which can be used is a fluid immiscible with the gaseous hydrocarbon and with the water of the aquifer W, and having a density lower than that of the water and higher than that of the gaseous hydrocarbon G. The treatment fluid FT is preferably injected directly into the aquifer W.

With reference to FIG. 3, in a third preferred embodiment, the method, object of the present invention, can be applied for reducing the gas coning phenomenon in the extraction of a liquid hydrocarbon fluid (oil O) present in a reservoir beneath a layer containing gas (cap gas GC). In this case, the treatment fluid FT which can be used is a fluid immiscible with the oil O and with the cap gas GC, and having a density higher than that of the cap gas GC and lower than that of the oil O. The treatment fluid FT is preferably injected directly into the cap gas GC.

As is evident to an expert in the field, it is still possible to obtain advantageous effects in reducing water and gas coning also by injecting the treatment fluid directly into the hydrocarbon fluid to be extracted. By suitably selecting the density and immiscibility characteristics, the treatment fluid will in any case migrate towards the contact interface between the hydrocarbon fluid and water or cap gas.

The injection of the treatment fluid into the subsoil is effected with the equipment and according to the techniques known in the state of the art in the field of the oil extraction industry.

The injections of the treatment fluid into the subsoil can be repeated until the positioning and formation of a permeability barrier having the desired sizes are obtained.

The injection strategy must be specifically verified in relation to the geometric characteristics of the well-reservoir-aquifer system and also to the petrophysical properties (in particular, permeability) of the rock which is housing the reservoir and aquifer. The injection of the treatment fluid, which can last for up to a few weeks, is preferably followed by the injection of water for a period of time in the order of a month. The water injected after the fluid forms an uncompressible volume whose purpose is to push the treatment fluid far away from the injection well and consequently to maximize the extension of the barrier at the oil/water interface for a certain quantity of barrier substance injected.

The permeability barrier may be able to prevent or in any case reduce the effects of coning phenomena for a limited period of time. With time, and as the extraction process proceeds, in fact, the level of the oil-water contact could be raised and the water could flow over the permeability barrier. The same phenomenon could take place, in a downward direction, in the case of gas coning.

By applying the method, object of the present invention, however, oil can be extracted for more or less prolonged periods of time (in the order of months) with little or no production of water or gas, thus significantly improving the overall extraction efficiency.

The fluid is generally injected into the subsoil in such a quantity that the permeability barrier can extend for a radius ranging from 5 m to 150 m from the extraction well, preferably from 12 m to 75 m, even more preferably from 25 m to 50 m. The thickness of the barrier which is formed is not critical and is normally within the range of a few centimeters to 15-20 centimeters.

The method, object of the present invention, can be applied to reservoirs of hydrocarbon fluids having different geological characteristics. Experimental determinations, although using mathematical models capable of simulating the effects of a permeability barrier obtained with the method, object of the present invention, have revealed that the above method produces the best results when the reservoir has a thickness ranging from 5 to 50 m, preferably from 5 to 30 m. In particular, the method proposed allows the best results to be obtained in medium-viscosity oil reservoirs (1-10 cP, preferably 2-5 cP), with a relatively small thickness of the aquifer (2-15 m, preferably 1-6 m) and a relatively low rock permeability (1-100 mD, preferably 1-50 mD).

The quantity of treatment fluid to be injected into the subsoil varies in relation, not only to the above characteristics of the desired permeability barrier, but also to other characteristics of the reservoir (for example, depth, temperature, viscosity of the hydrocarbon fluid, etc.), aquifer and/or cap gas.

The quantity of fluid to be injected can be easily determined by an expert in the field on the basis of the above parameters and simple routine experimental tests, as is normally the case in this field. Depending on the sizes of the reservoir, from 10 to 100, preferably from 20 to 60 m³/day of treatment fluid are conveniently injected for periods ranging from 20 to 150, preferably from 30 to 90 days.

The method, object of the present invention, allows a permeability barrier capable of considerably reducing the effects of water and gas coning, to be formed in situ, in the subsoil.

The permeability barrier is capable of preventing or in any case reducing the effects of coning phenomena for a limited period of time. With time and as the extraction process proceeds, in fact, the water coming from the aquifer or the cap gas can in any case penetrate preferential courses (for example, fractures) inside the porous rocks and flow over the permeability barrier. The time necessary for this phenomenon to happen, however, is relatively long, even up to 2-3 years. Within this period of time, therefore, by applying the method object of the present invention, a hydrocarbon fluid having reduced water or gas cuts can be extracted, significantly improving the overall extraction efficiency.

Once the effect of positioning a first permeability barrier has been exhausted, the method can also be applied again, once or various times, to form new permeability barriers.

The method according to the present invention, has proved to be particularly effective when coning phenomena have not yet begun to manifest their negative effects (i.e. the water or gas cut present in the fluid extracted is still at limited levels). The expert in the field can possibly accomplish adequate controls, with known techniques suitable for the purpose, in order to determine sufficiently in advance, the incipient occurrence of new coning phenomena.

The following embodiment examples are provided for purely illustrative purposes of the present invention and should by no way be intended as limiting the protection scope as defined by the enclosed claims.

### EXAMPLE 1

The ability was experimentally tested to form a barrier at the oil-water interface, by using a 10% by weight SPUR®-1050 silicone resin in the HS-1023 solvent, at a temperature of 70° C.

The SPUR®-1050 resin is a commercial silicone resin produced by Momentive Performances Materias, never proposed for use in the achievement of barriers according to the present invention. Essentially, it is based on urethane-silicone polymers capable to crosslink with controlled kinetics, in the presence of humidity, as a function of its concentration in the solvent, thus producing a very resistant (gel) material. Its substantial insolubility both in water and mineral oil has been verified.

A dual injection test was carried out, with the aim to simulate the injection of the SPUR® solution and the subsequent production phase in the vicinity of the well. On a core constituted by a horizontally positioned sandpack, composed of 40-60 mesh sand having the following characteristics:

Length: 15 cm

Diameter: 5.08 cm

schematically represented as follows:

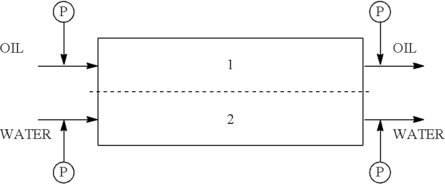

wherein (p) represents a pressure detector.

The following fluids were used:
Synthetic Sea Water (Brine), having density 0.9465 g/cc and viscosity 0.4058 cP, at 70° C.
Well crude oil (Ragusa 33 well)
Blocking solution: 10% SPUR®-1050 in HS-1023 solvent (produced by Halliburton, has a flash point higher than 100° C.) having viscosity 5.8 mPa's at 25° C. and density about 0.870 g/cc.

The upper zone was saturated with oil and the lower zone was saturated with Brine. The two fluids were injected at the same flow, by mean of two independent pumps, so as to avoid any cross-flow of the fluids. The core remain divided into two superimposed volumes for a time long enough to make the test reliable. An oil-water interface is formed, that simulates the actual case of a reservoir over an aquifer.

The 10% SPUR® solution in HS-1023 solvent is then injected into zone 2, while the contemporary injection of the oil into zone 1. The system is then hermetically sealed for 20 days and the temperature maintained. The SPUR®-1050 containing organic phase, slowly migrates to the oil-water interface before crosslinking.

At the end, the formation of a barrier was observed at the oil-water interface. Oil and Brine are injected again, noticing a (initial permeability)/(final permeability) ratio (also known as Residual Resistant Factor, RRF) of about 11 for the aqueous phase. The block obtained after crosslinking of the polymer has revealed to be effective and stable with time.

### EXAMPLE 2

The effect of a permeability barrier obtained with the method object of the present invention, and positioned at the oil/water or oil/gas interface, was simulated, by means of the simulation program called “ECLIPSE Black Oil” (produced by Schlumberger), in an oil reservoir subject to water or gas coning respectively, by injecting into the subsoil, a treatment fluid with an intermediate density between the two fluids forming the interface, for example of the type that was used in the previous example 1.

The calculation program estimated the recovery factor (RF) of the hydrocarbon fluid consisting of two different types of oil (medium and light), in the case of both water coning and gas coning.

The recovery factor is the ratio between the quantity of hydrocarbon which is estimated as being produced and the quantity of hydrocarbon originally in the reservoir.

For both simulations, the following properties of the reservoir were assumed, for the purposes of the calculation (Table 1):

TABLE 1

| | Medium oil | Light oil |
|---|---|---|
| Density (API) | 30° | 45° |
| Pressure BHP (psi) | 150 | 1500 |
| Viscosity (cP) | 2 | 0.3 |

The calculation of the RF value was effected assuming that the reservoir had a thickness of 10 m, 20 m or 30 m.

A permeability value equal to zero mD was calculated for the permeability barrier. Four different simulation tests were performed, relating to the formation of four circular-shaped barriers having four diameter values equal to 25 m, 50 m, 100 m and 150 m, respectively.

In the case of water coning, the following assumptions were made regarding the characteristics of the aquifer:

| Rock compressibility | 4 · 10⁻⁶ | psi⁻¹ |
|---|---|---|
| Water compressibility | 3 · 10⁻⁶ | psi⁻¹ |
| Density of the water | 1.03 | (specific gravity) |
| Water formation volumetric | 1.01 | bbl/bbl_{ST} |
| factor | | |
| Viscosity of the water | 0.5 | cP |

A continuative production of the extraction well with a duration of 3 years, was also assumed.

The results of the calculation of the RF value, in the case of water coning, are indicated in Table 2 below, wherein ΔRF(%) represents the percentage increase with respect to extraction under identical conditions, but in the absence of a permeability barrier.

TABLE 2

ΔRF (%)
Diameter of barrier (m)

| | | 25 | 50 | 100 | 150 |
|---|---|---|---|---|---|
| SG⁽¹⁾ = 10 m | Medium | 3 | 10 | 42 | 99 |
| SG⁽¹⁾ = 10 m | Light | 0.2 | 1 | 5 | 11 |
| SG⁽¹⁾ = 20 m | Medium | 2 | 11 | 45 | 92 |
| SG⁽¹⁾ = 20 m | Light | 0.2 | 1 | 5 | 12 |
| SG⁽¹⁾ = 30 m | Medium | 1 | 5 | 23 | 56 |
| SG⁽¹⁾ = 30 m | Light | 0.1 | 1 | 5 | 13 |

⁽¹⁾SG = thickness of reservoir

In the case of a reservoir subject to gas coning, a gas gravity value (ratio between the molecular weight of the cap gas and that of the air) equal to 0.8646 was assumed for the cap gas, together with a formation rate equal to 5.66·10⁴ l/bbl_{ST} (1 bbl=158.987 l).

The results of the calculation of the RF value, in the case of gas coning, are indicated in Table 3 below.

TABLE 3

ΔRF (%)
Diameter of barrier (m)

| | Oil type | 25 | 50 | 100 | 150 |
|---|---|---|---|---|---|
| SG⁽¹⁾ = 10 m | Medium | 10 | 44 | 173 | 407 |
| SG⁽¹⁾ = 10 m | Light | 3.9 | 10 | 52 | 132 |
| SG⁽¹⁾ = 20 m | Medium | 3 | 16 | 64 | 156 |
| SG⁽¹⁾ = 20 m | Light | 2.0 | 6 | 23 | 54 |
| SG⁽¹⁾ = 30 m | Medium | 1 | 6 | 26 | 66 |
| SG⁽¹⁾ = 30 m | Light | 1.0 | 3 | 11 | 25 |

⁽¹⁾SG = thickness of reservoir

The results of the simulation showed that with the method, object of the present invention, significant increases in the RF recovery factor can be obtained, in particular when large-dimensioned barriers are used. Furthermore, the results show that the effectiveness of the above method also depends on the thickness of the reservoir and viscosity of the barrier.

1. A method for limiting the water or gas coning in an extraction well of a hydrocarbon fluid from an underground reservoir, said reservoir being close to an aquifer or a cap gas, said method comprising:
i) injecting a treatment fluid into the subsoil, having an intermediate density between that of the hydrocarbon fluid and that of the water of the aquifer or the cap gas, said treatment fluid being insoluble in said hydrocarbon fluid, said water, and/or said cap gas;
ii) waiting for the treatment fluid to settle by gravity or hydrostatic thrust at the hydrocarbon fluid/water or hydrocarbon fluid/gas interface;
iii) in situ activating said treatment fluid and forming a permeability barrier with respect to the water of the aquifer or the cap gas.

2. The method of claim 1, wherein the hydrocarbon fluid is a hydrocarbon oil or a hydrocarbon gas.

3. The method of claim 1, wherein the in situ activation takes place by contacting the treatment fluid with one of the two phases at the contact interface.

4. The method of claim 1, wherein the treatment fluid is injected into said aquifer or cap gas.

5. The method of claim 1, wherein the hydrocarbon fluid is a hydrocarbon oil and the treatment fluid is injected into the aquifer, said treatment fluid having a density lower than that of the water and higher than that of said hydrocarbon oil.

6. The method of claim 1, wherein the hydrocarbon fluid is a hydrocarbon oil and the treatment fluid is injected into said cap gas, said treatment fluid having a density higher than that of said gas and lower than that of said hydrocarbon oil.

7. The method of claim 1, wherein the hydrocarbon fluid is a hydrocarbon gas and the treatment fluid is injected into the aquifer, said treatment fluid having a density lower than that of the water and higher than that of said hydrocarbon gas.

8. The method of claim 1, wherein the fluid is injected in such a quantity that the permeability barrier extends for a radius ranging from 5 m to 150 m from the extraction well.

9. The method of claim 1, wherein the fluid is injected in such a quantity that the permeability barrier has a thickness of up to 20 cm.

10. The method of claim 1, wherein the reservoir has a thickness ranging from 5 m to 50 m.

11. The method of claim 1, wherein the injecting (i) comprises a first injection of a first treatment fluid comprising a monomer or a pre-polymer and a subsequent injection of a second treatment fluid comprising a polymerization initiator.

12. The method of claim 1, wherein the injecting (i) comprises a first injection of a first treatment fluid comprising colloidal silica and a subsequent injection of a second treatment fluid comprising a surfactant.

13. A confinement system of an underground reservoir of a hydrocarbon fluid, said reservoir being close to an aquifer or cap gas, said confinement system comprising a permeability barrier to the water of the aquifer or cap gas, at the hydrocarbon fluid/water interface or hydrocarbon fluid/gas interface, consisting of a treatment fluid, optionally activated in situ, having an intermediate density between that of said hydrocarbon fluid and that of said water or said cap gas, said treatment fluid also being insoluble in said hydrocarbon fluid, said water, and/or said gas.

14. The method of claim 8, wherein the permeability barrier extends for a radius ranging from 12 m to 75 m from the extraction well.

15. The method of claim 8, wherein the permeability barrier extends for a radius ranging from 25 m to 50 m from the extraction well.

16. The method of claim 10, wherein the reservoir has a thickness ranging from 5 m to 30 m.
